(19) United States
(12) Patent Application Publication
(10) Pub. No.: US 2017/0268600 A1
(43) Pub. Date: Sep. 21, 2017

(54) SUPPORT FOR A PENDULUM DAMPING DEVICE, AND PENDULUM DAMPING DEVICE COMPRISING SUCH A SUPPORT

(71) Applicant: VALEO EMBRAYAGES, Amiens Cedex 2 (FR)

(72) Inventors: Michael HENNEBELLE, Houdain (FR); Giovanni GRIECO, Colombes (FR); Roel VERHOOG, Gournay Sur Aronde (FR); David SALVADORI, Le Mesnil En Thelle (FR)

(21) Appl. No.: 15/464,814

(22) Filed: Mar. 21, 2017

(30) Foreign Application Priority Data
Mar. 21, 2016 (FR) 1652377

(51) Int. Cl. F16F 15/14

(52) U.S. Cl. CPC F16F 15/145; F16F 2226/04; F16F 2226/02

(57) ABSTRACT

A support (4) for a pendulum damping device (2), comprising:
a first portion (7) capable of being connected to a component (1) of a motor vehicle transmission system; and
a second portion (8) in which is configured at least one first raceway capable of interacting with a bearing member (21) in order to guide the displacement of a pendulum assembly (5),
   the first portion (7) and the second portion (8) being rigidly connected to one another, and the first portion (7) being obtained by cutting out the central zone of the second portion (8).

### CROSS-REFERENCE TO RELATED APPLICATIONS AND CLAIM TO PRIORITY

This application is related to Patent Application No. 1652377 filed Mar. 21, 2016 in France, the disclosure of which is incorporated herein by reference and to which priority is claimed.

### FIELD OF THE INVENTION

The present invention relates to a pendulum damping device, in particular for a motor vehicle transmission system.

### BACKGROUND OF THE INVENTION

In such an application, the pendulum damping device may be incorporated into a torsional damping system of a clutch capable of selectively connecting the combustion engine to the gearbox in order to filter vibrations due to irregularities of the engine. One torsional damping system of this kind is, for example, a dual mass flywheel.

As a variant, in such an application the pendulum damping device may be incorporated into to a friction disc of the clutch or into a hydrodynamic torque converter or into a flywheel integral with the crankshaft or into a dual dry or wet clutch.

A pendulum damping device of this kind conventionally uses a support and one or more pendulum assemblies movable with respect to that support, the displacement of each pendulum assembly with respect to the support being guided by two bearing members interacting on the one hand with raceways integral with the support, and on the other hand with raceways integral with the pendulum assembly.

The support of the pendulum damping device must generally
on the one hand ensure physical attachment of the pendulum damping device to the remainder of the transmission system, and
on the other hand be sufficiently robust to guide the displacement of the pendulum assemblies while withstanding the impacts of those pendulum assemblies upon it during operation.

In order to meet these two requirements it is known to utilize a support having two distinct portions, one of those portions of the support being specific to the physical attachment to the remainder of the transmission system, and the other of those portions being specific to guidance of the displacement of the pendulum bodies. Such a support is, however, costly to implement.

There is a need to take into account the two requirements mentioned above in a simple and inexpensive manner.

### SUMMARY OF THE INVENTION

The object of the invention is to meet this need, which it does according to one of its aspects with the aid of a support for a pendulum damping device comprising:
a first portion capable of being connected to a component of a motor vehicle transmission system; and
a second portion in which is configured at least one first raceway capable of interacting with a bearing member in order to guide the displacement of a pendulum assembly,

the first portion and the second portion being rigidly connected to one another, and the first portion being obtained by cutting out the central zone of the second portion.

According to the invention, the first portion and the second portion of the support are implemented from only one part, for example a sheet of steel. As a consequence, it is not necessary to resort to two different original parts in order to implement the support. The scrap of the second part then forms the first portion of the support.

The separation of the original part into two portions then allows each portion of the support to be adapted to the requirement that that portion must meet, prior to rigid coupling between the two portions. For example, after being cut out the second portion is subjected to a hardening treatment in order to increase its strength. This treatment is, for example, a heat treatment allowing an addition of carbon in order to harden the second portion of the support. The addition of carbon is accomplished, for example, by carbonitriding or nitriding. This hardening treatment then does not affect the first portion of the support which has been separated from the second portion of the support, which is that much more advantageous given that a heat treatment of this kind may make it more difficult to attach the first portion of the support, by welding, to the remainder of the transmission system.

As a variant or a complement, a coating allowing vibrations of the support to be attenuated in the context of an impact by the mass against that support may be deposited onto the second portion of the support once the first portion has been cut out. The coating may be made of Deltaflon™ marketed by the Fluorotechnique® company. This coating may be applied onto the support by spraying, by electrolysis, or in a vapor phase. A coating of this kind utilizes PTFE.

The first raceway or raceways may already have been configured in the second portion of the support when the first portion is cut out.

As a variant, the first raceway or raceways may not yet have been configured in the second portion of the support when the first portion is cut out.

For purposes of the present application:
“axially” means “parallel to the rotation axis of the support,”
“radially” means “along an axis belonging to a plane orthogonal to the rotation axis of the support and intersecting that rotation axis of the support,”
“angularly” or “circumferentially” means “around the rotation axis of the support,”
“orthoradially” means “perpendicularly to a radial direction,”
“integral” means “rigidly coupled,” and
the “inactive position” of a pendulum assembly is the one in which that pendulum assembly is centrifuged without being subjected to torsional oscillations deriving from irregularities of the combustion engine.

The first portion of the support may have on its radially external periphery an alternation of solid regions and open regions, the second portion of the support having on its radially internal periphery an alternation of solid regions and open regions. Moving along a given diameter, on the one hand an alternation of solid regions and open portions of the first portion of the support, and on the other hand an alternation of solid regions and open regions of the second portion of the support, may then be encountered.

Each solid and open region of the first portion of the support may respectively have a shape complementary to that of a respective open and solid region of the second portion of the support. This complementarity of shape may result from the first portion being cut out of the second portion of the support.

Each solid region of the first portion of the support has, for example, a petal shape in a plane orthogonal to the rotation axis.

The entirety of the solid regions of the first portion of the support here forms the radially external zone of the first portion of the support. Each solid region of the first portion of the support extends, for example, radially outward from a ring forming the radially internal zone of the first portion of the support. The support may be attached to the remainder of the transmission via this radially internal zone of the first portion of the support.

The first portion of the support may be axially offset with respect to the second portion of the support. The first portion of the support may extend for the most part radially inside the second portion of the support.

Each solid and open region of the first portion of the support may respectively be axially opposite all or part of a respective solid and open region of the second portion of the support. In other words, when the first portion and the second portion of the support are rigidly connected, for example once the treatments mentioned above have been performed, the first and the second portion are positioned in such a way that the solid regions of the first portion of the support are axially opposite solid regions of the second portion of the support.

The rigid connection between the first and the second portion of the support may utilize coupling members, each coupling member being received in a zone of a solid region of the first portion of the support, and in a zone of a solid region of the second portion of the support, which are axially opposite. These coupling members may be rivets extending axially. Each solid region of the first portion of the support may be connected rigidly to a solid region of the second portion of the support via at least one coupling member, in particular at least one rivet.

As a variant, the rigid connection between the first portion and the second portion of the support utilizes a force fit. The solid regions of the first portion of the support may have different dimensions with respect to one another. A solid region of the first portion of the support of a first type thus has, for example, a small radially internal dimension and a large radially external dimension, while a solid region of the first portion of the support of a second type has a large radially internal dimension and a small radially external dimension. The rigid connection is then effected by force-fitting
the solid regions of the first portion of the support of the first type into open regions of the second portion of the support which result from cutting out solid regions of the first portion of the support of the second type, and
the solid regions of the first portion of the support of the second type into open regions of the second portion of the support which result from cutting out solid regions of the first portion of the support of the first type.

Force fitting is thus performed for each solid region of the first portion of the support of the first type at its radially external dimension, while force fitting is performed for each solid region of the first portion of the support of the second type at its radially internal dimension.

A further object of the invention according to another of its aspects is a pendulum damping device comprising:
a support as defined above, and
at least one pendulum assembly movable with respect to the support, the displacement of that pendulum assembly with respect to the support being guided by at least one bearing member interacting on the one hand with the first raceway and on the other hand with at least one second raceway integral with the pendulum assembly.

The displacement of the pendulum assembly with respect to the support may be guided by two bearing members, in which case the damping device is referred to as “bifilar.”

Each bearing member interacts, for example, with at least one first raceway integral with the support and with at least one second raceway integral with the pendulum assembly. Each bearing member interacts, for example, with the raceway or raceways integral with the support, and with the raceway or raceways integral with the pendulum, only via its external surface.

Each bearing member is, for example, a roller circular in section in a plane perpendicular to the rotation axis of the support. This roller may comprise several successive cylindrical regions of different radii. The axial ends of the roller maybe devoid of a terminal annular rim. The roller is made, for example, of steel. The roller maybe hollow or solid.

In all of the above, the device comprises, for example, a number of pendulum assemblies between two and eight, in particular three, four, five, or six pendulum assemblies. All these pendulum assemblies may be successive to one another circumferentially. The device may thus comprise a plurality of planes, perpendicular to the rotation axis, in each of which all the pendulum assemblies are arranged.

In all of the above, the shape of the aforesaid first and second raceways may be such that each pendulum assembly is displaced with respect to the support only in translation around a notional axis parallel to the rotation axis of the support.

As a variant, the shape of the raceways may be such that each pendulum assembly is displaced with respect to the support
both in translation around a notional axis parallel to the rotation axis of the support,
and in rotation around the center of gravity of said pendulum mass, such a motion also being called a “combined motion” and being disclosed, for example, in the Application DE 10 2011 086 532.

According to an exemplifying embodiment of the invention, the pendulum assembly may comprise a first pendulum mass arranged axially on a first side of the second portion of the support and a second pendulum mass arranged axially on a second side of the second portion of the support, the first and the second pendulum mass being integrated with one another via at least one connecting member.

According to this exemplifying embodiment of the invention the pendulum damping device may comprise a system for attenuating the noise produced upon an impact of the pendulum assembly against the support, this attenuation system being arranged axially on each side of the second portion of the support and axially clamping the latter.

The attenuation system may allow consideration of the undesirable noise and/or vibration of the support which occur in particular upon starting or shutdown of the combustion engine of the vehicle. This is because starting and shutdown of the combustion engine correspond to low engine speeds, which may result in a desynchronization of the pendulum assemblies with respect to the support, so that the pendulum assemblies may drop radially and strike against the support. Such an impact may then cause undesirable vibration and/or noise.

The noise attenuation system may comprise a first element arranged axially on a first side of the second portion of the support and a second element arranged axially on a second side of that second portion of the support.

This first and this second element may be separate parts integrated with the support, for example with the second portion of the support, in particular by fastening onto zones of the second portion of the support which are arranged radially beyond the solid regions of that second portion. Said fastening is accomplished, for example, by bolting, riveting, ultrasonic welding, thermal welding, etc.

Each element of the attenuation system may have on its radially internal periphery an alternation of solid regions and open regions. There exists, for example, an open region of the first element of said system which is axially opposite a solid region of the second element of said system while being axially opposite an open region of the first portion of the support and an open region of the second portion of the support. These two elements of the attenuation system may be fastened to one another via said two solid regions through the open axial space configured by the open regions of the support.

As a variant, there may exist zones of each element of the noise attenuation system which are axially opposite a solid region of the first portion of the support and opposite a solid region of the second portion of the support, and fastening of the noise attenuation system to the support may be accomplished via screws or rivets received in those zones and those solid regions. Other means may also be utilized for said fastening.

As yet another variant, the first and the second element of the noise attenuation system may be a single part overmolded onto the second portion of the support.

The second portion of the support may carry at least one axial interposition part arranged axially opposite the first pendulum mass or the second pendulum mass, that axial interposition part being in particular a coating deposited onto the support.

An interposition part of this kind may thus limit the axial displacement of the pendulum mass with respect to the support, thus avoiding axial impacts between said parts and therefore undesirable wear and noise, in particular when the support and/or the pendulum mass are made of metal.

When the interposition part is a coating, that coating is, for example, as mentioned previously.

As a variant, the axial interposition part may be a slider carried by the support. This slider may be made of plastic and may be hooked onto the support via one or more fastening tabs mounted in one or more support holes.

The interposition parts may be positioned on the support in such a way that there is always at least one interposition part at least a portion of which is axially interposed between a pendulum mass and the support, regardless of the relative positions of the support and of said mass.

According to this exemplifying embodiment, each pendulum assembly may comprise at least one abutment damping member capable of coming into contact simultaneously with the pendulum assembly and the support in relative positions of the pendulum assembly with respect to the support. Those relative positions are, for example:
the position following a displacement in the counter-clockwise direction of said pendulum assembly from the inactive position in order to filter a torsional oscillation, and/or
the position following a displacement in the clockwise direction of said pendulum assembly from the inactive position in order to filter a torsional oscillation, and/or
the position following a radial drop of said pendulum assembly, in particular upon starting or shutdown of the vehicle's engine.

Each abutment damping member may be dedicated to one connecting member of the pendulum assembly and carried by the latter. Each abutment damping member may have elastic properties allowing damping of the impacts associated with contact between the support and the pendulum assembly. That damping is then permitted by a compression of the abutment damping member, the latter being made, for example, of elastomer or of rubber.

The noise attenuation system may be different from an abutment damping member, in which case the noise attenuation system does not damp the abutment of the pendulum assembly against the support while simultaneously coming into contact with the pendulum assembly and the support.

According to a first preferred implementation, the bearing member interacts with only one first raceway and only one second raceway, and that second raceway is defined by the connecting member of the pendulum assembly. A region of the contour of that connecting member defines, for example, the second raceway. As a variant, a coating may be deposited onto that region of the contour of the connecting member in order to form the second raceway. A connecting member of this kind is, for example, force-fitted via each of its axial ends into an opening configured in one of the pendulum masses. As a variant, the connecting member may be welded or bolted or riveted via its axial ends onto each pendulum mass.

According to the first preferred implementation, the displacement of each pendulum assembly with respect to the support may be guided by at least two bearing members, in particular exactly two bearing members. Two connecting members, each interacting with one bearing member, may be provided.

Each bearing member may then be loaded only in compression between the first and second raceways mentioned above. Those first and second raceways which interact with the same bearing member may be at least in part radially opposite, i.e. there exist planes perpendicular to the rotation axis in which both of said raceways extend.

According to the first preferred implementation, each bearing member may be received in a window of the support which already receives a connecting member and does not receive any other bearing member. That window is defined, for example, by a continuous contour, a region of which defines the first raceway, integral with the support, which interacts with that bearing member.

According to a second preferred implementation, the bearing member interacts on the one hand with only one first raceway integral with the support, and on the other hand with two second raceways integral with the pendulum assembly. Each pendulum mass then has an opening, a portion of whose contour defines one of those second raceways.

According to this second preferred implementation, each connecting member encompasses, for example, several rivets, and that connecting member is received in a window of the support, while the bearing member is received in an opening of the support different from a window that receives a connecting member.

According to this second preferred implementation, two bearing members may guide the displacement of the pendulum assembly with respect to the support, and each bearing member interacts with a first raceway dedicated to that bearing member and with two second raceways dedicated to that bearing member.

According to this second preferred implementation, each bearing member may then comprise, axially successively:
a region arranged in an opening of the first pendulum mass and interacting with the second raceway formed by a portion of the contour of that opening,
a region arranged in an opening of the support and interacting with the first raceway formed by a portion of the contour of that opening, and
a region arranged in an opening of the second pendulum mass and interacting with the second raceway formed by a portion of the contour of that opening.

According to this first exemplifying embodiment, there exists a single support that guides, via its second portion, the displacement of the pendulum bodies.

According to a second exemplifying embodiment, the displacement of each pendulum assembly may be guided by two supports, each being as mentioned above. Those two supports are then axially offset and integral. In this case the pendulum assembly may comprise only a single pendulum mass arranged axially between the two supports, or if applicable several pendulum masses integrated with one another and arranged axially between the two supports.

According to this second exemplifying embodiment of the invention, each support may carry a system for attenuating noise produced upon an impact of the pendulum assembly onto that support, that attenuation system being arranged axially on either side of the support and axially clamping the latter. As a variant, the noise attenuation system associated with each support is arranged axially only on that side of the support which faces toward the pendulum assembly.

A further object of the invention according to another of its aspects is a component for a transmission system of a motor vehicle, the component being in particular a dual mass flywheel, a hydrodynamic torque converter, a flywheel integral with the crankshaft, or a clutch friction disc, or a component of a hybrid transmission system, or a dual dry or wet clutch, or a single wet clutch, said component comprising a pendulum damping device as defined above.

The pendulum damping support may then be one among:
a flange of the component,
a guide washer of the component,
a phase washer of the component, or
a support different from said flange, said guide washer, and said phase washer.

In the case in which the device is integrated into a flywheel integral with the crankshaft, the support may be integral with that flywheel.

The component is in particular a clutch friction disc. In such a case, the support may be connected to the hub of the friction disc. The first part of the support is, for example, fastened, in particular welded, onto that hub.

A further object of the invention according to another of its aspects is a method for producing a support for a pendulum damping device, comprising the following steps:
cutting out the central zone of a metal sheet in order to form a first support portion capable of being connected to a component of a vehicle transmission system, the remainder of the sheet forming a second support portion having at least one first raceway capable of interacting with a bearing member in order to guide the displacement of a pendulum assembly, and
rigidly connecting the first portion and the second portion.

The method may comprise the step according to which the second part is subjected, after the cutting-out step and before the step of rigidly connecting the first portion, to a hardening treatment, for example carbonitriding or nitriding.

All or part of what has been mentioned with respect to the preceding aspect of the invention is also applicable to this other aspect.

### BRIEF DESCRIPTION OF THE DRAWINGS

A better understanding of the invention will be gained from reading the description below of a non-limiting exemplifying embodiment thereof, and from an examination of the attached drawings, in which:

FIG. 1 depicts, in part and in exploded fashion, a transmission system component having a pendulum damping device; and

FIG. 2 depicts the component of FIG. 1 when it is assembled.

### DETAILED DESCRIPTION OF THE PREFERRED EMBODIMENT(S)

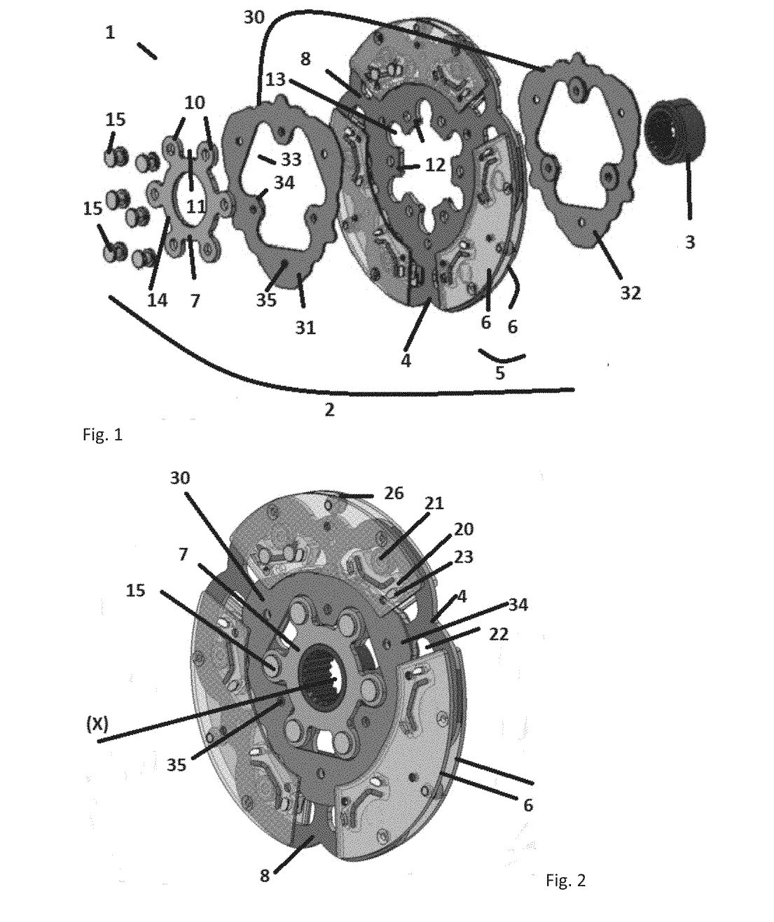

FIG. 1 depicts a transmission system component 1 comprising a pendulum damping device 2 according to an exemplifying embodiment of the invention.

That component 1 is in this case a clutch friction disk, only hub 3 being depicted here. That component 1 is associated, for example, with a combustion engine, in particular having two, three, or four cylinders.

In the example considered, pendulum damping device 2 comprises:
a support 4 capable of moving rotationally around an axis X, and
a plurality of pendulum assemblies 5 movable with respect to support 4.

Three pendulum assemblies 5 are provided in the example considered, being distributed uniformly around axis X.

It is evident from FIGS. 1 and 2 that support 4 here comprises two different portions 7 and 8.

First portion 7 extends for the most part radially inside second portion 8, and that first portion 7 serves to physically attach pendulum damping device 2 to hub 3, in particular by welding.

Second portion 8 serves to guide the displacement of pendulum assemblies 5, as will be seen later.

First portion 7 is produced here by cutting out the central zone of second portion 8 of the support.

As is evident from FIG. 1, in the example described, first portion 7 of support 4 has on its radially external periphery an alternation of solid regions 10 and open regions 11.

Similarly, second portion 8 of support 4 has on its radially internal periphery an alternation of solid regions 12 and open regions 13.

Because of the cutting that is performed, each solid region 10 of first portion 7 of the support has a shape complementary to the shape of each open region 13 of second portion 8 of support 4, and each solid region 12 of second portion 8 of support 2 has a shape complementary to the shape of each open region 11 of first portion 7 of support 4. It is thus evident that each solid region 10 is in the shape of a petal extending radially outward from a ring 14 fastened on hub 3.

As is evident from FIG. 2, in the assembled state each solid region 10 of first portion 7 of support 4 is axially opposite a solid region 12 of second portion 8 of support 4. Similarly, each open region 11 of first portion 7 of support 4 is axially opposite an open region 13 of second portion 8 of support 4.

Each solid region 10 and 12 has in this case a through hole, and the positioning of first portion 7 and of second portion 8 of support 4 allows those two holes to be axially aligned so that a screw or a rivet 15, forming a coupling member, is received through those two holes.

In the example considered, second portion 8 of support 4 has overall an annular shape having two opposite sides that in this case are planar faces.

As is evident from FIGS. 1 and 2, in the example considered each pendulum assembly 5 comprises:
two pendulum masses 6, each pendulum mass 6 extending axially oppositely from one side of second portion 7 of support 4, and
two connecting members 20 integrating the two pendulum masses 6.

In the example considered, connecting members 20, also called “spacers,” are offset angularly.

In FIGS. 1 and 2 pendulum damping device 2 is inactive, i.e. it is not filtering torsional oscillations transmitted by the drivetrain as a result of irregularities of the combustion engine.

In the example shown in the Figures, each end of a connecting member 20 is welded onto a pendulum mass 6. In variants, each of those ends may be force-fitted into an opening configured in one of pendulum masses 6 of pendulum assembly 5 in order to integrate those two pendulum masses 6 with one another.

Each connecting member 20 extends in part in a window 22 configured in second portion 7 of support 4. In the example considered, window 22 defines an open space inside the support, that window being delimited by a continuous contour.

In the example considered, device 2 also comprises bearing members 21 that guide the displacement of pendulum assemblies 5 with respect to support 4. The bearing members are, for example, rollers.

In the example described, the movement of each pendulum assembly 5 with respect to support 4 is guided by two bearing members 21, each of them interacting, in the example shown in the Figures, with one of connecting members 20 of pendulum assembly 5.

Each bearing member interacts here with only one first raceway integral with support 4, and with only one second raceway integral with pendulum assembly 5, in order to guide the displacement of pendulum assembly 5.

In the example considered, each second raceway is formed by a radially external edge region of a connecting member 20.

Each first raceway is defined by a portion of the contour of a window 22.

Each first raceway is thus arranged radially opposite a second raceway, so that the same bearing surface of a bearing member 21 rolls alternatively on the first raceway and on the second raceway. The bearing surface of bearing member 21 is in this case a cylinder of constant radius.

As is evident from FIGS. 1 and 2, damping members for the abutment of pendulum assembly 5 against support 4 are provided. First abutment damping members 23 are carried by the pendulum assembly, each connecting member 20 being associated with one first abutment damping member 23. Those first abutment damping members 23 are configured here to be interposed between the associated connecting member 20 and the radially internal edge of window 22 that receives that connecting member 20. Second abutment damping members 26 are provided, also being carried by pendulum assembly 5 and configured to come into abutment against the radially external edge of second portion 8 of support 4 for low radial positions of that pendulum assembly 5.

As is also evident from FIGS. 1 and 2, in the example considered component 1 also comprises a system 30 for attenuating the noise produced upon impact of pendulum assembly 5 against support 4. This attenuation system 30 is arranged in this case on either side of second portion 8 of support 4, and axially clamps the latter.

Attenuation system 30 comprises here a first element 31 arranged axially on a first side of second portion 8 of support 4, and a second element 32 arranged axially on a second side of said second portion 8.

This first element 31 and this second element 32 are in this case separate parts integrated with second portion 8 of support 4, that integration involving in particular a bolting operation or hot riveting of plastic rivets.

As is evident from FIGS. 1 and 2, each element 31 and 32 of attenuation system 30 has on its radially internal periphery an alternation of open regions 33 and solid regions 34. It is apparent from FIG. 2 that each solid region 34 of first element 31 is axially opposite a solid region 34 of second element 32, while being axially opposite an open region 11 of first portion 7 of support 4 and an open region 13 of second portion 8 of support 4. These solid regions 34 each have a hole 35, and those two holes are aligned in order to receive a screw or rivet arranged axially in open regions 11 and 13 of the first and second portion of support 4.

The invention is not limited to the example that has just been described.

1. A support (4) for a pendulum damping device (2), comprising:
a first portion (7) capable of being connected to a component (1) of a motor vehicle transmission system; and
a second portion (8) in which is configured at least one first raceway capable of interacting with a bearing member (21) in order to guide the displacement of a pendulum assembly (5),
the first portion (7) and the second portion (8) being rigidly connected to one another, and the first portion (7) being obtained by cutting out the central zone of the second portion (8).

2. The support according to claim 1, wherein the first portion (7) of the support (4) having on its radially external periphery an alternation of solid regions (10) and open regions (11), the second portion (8) of the support (4) having on its radially internal periphery an alternation of solid regions (12) and open regions (13).

3. The support according to claim 2, wherein each solid region (10) and open region (11) of the first portion (7) of the support respectively having a shape complementary to that of a respective open region (13) and solid region (12) of the second portion (8) of the support (4).

4. The support according to claim 2, wherein each solid region (10) and open region (11) of the first portion (7) of the support (4) respectively being axially opposite all or part of a respective solid region (12) and open region (13) of the second portion (8) of the support (4).

5. The support according to claim 4, wherein the rigid connection utilizing coupling members (15), each coupling member (15) being received in a zone of a solid region (10) of the first portion (7) of the support (4) and in a zone of a solid region (12) of the second portion (8) of the support (4), said zones being axially opposite.

6. A pendulum damping device (2) comprising:
a support (4) according to claim 1, and
at least one pendulum assembly (5) movable with respect to the support (4), the displacement of that pendulum assembly (5) with respect to the support (4) being guided by at least one bearing member (21) interacting with the first raceway and with at least one second raceway integral with the pendulum assembly (5).

7. The damping device according to claim 6, wherein the pendulum assembly (5) comprising a first pendulum mass (6) arranged axially on a first side of the second portion (8) of the support (4) and a second pendulum mass (6) arranged axially on a second side of the second portion (8) of the support (4), the first and the second pendulum mass (6) being integrated with one another via at least one connecting member (20).

8. The device according to claim 6, further comprising a system (30) for attenuating the noise produced upon an impact of the pendulum assembly (5) against the support (4), said system (30) being arranged axially on each side of the second portion (8) of the support (4) and axially clamping the latter.

9. The device according to claim 8, wherein the noise attenuation system (30) comprising a first element (31) arranged axially on a first side of the second portion (8) of the support (4) and a second element (32) arranged axially on a second side of the second portion (8) of the support (4), the first element (31) and the second element (32) being separate parts integrated with the support (4).

10. The device according to claim 8, wherein the noise attenuation system (30) being different from an abutment damping member simultaneously coming into contact with the pendulum assembly (5) and the support (4) in order to damp the abutment of the pendulum assembly (5) against the support (4).

11. A clutch friction disc (1) comprising a pendulum damping device (2) according to claim 6.

12. The support according to claim 3, wherein each solid region (10) and open region (11) of the first portion (7) of the support (4) respectively being axially opposite all or part of a respective solid region (12) and open region (13) of the second portion (8) of the support (4).

13. A pendulum damping device (2), comprising:
a support (4) according to claim 2, and
at least one pendulum assembly (5) movable with respect to the support (4), the displacement of that pendulum assembly (5) with respect to the support (4) being guided by at least one bearing member (21) interacting on the one hand with the first raceway and on the other hand with at least one second raceway integral with the pendulum assembly (5).

14. A pendulum damping device (2), comprising:
a support (4) according to claim 3, and
at least one pendulum assembly (5) movable with respect to the support (4), the displacement of that pendulum assembly (5) with respect to the support (4) being guided by at least one bearing member (21) interacting on the one hand with the first raceway and on the other hand with at least one second raceway integral with the pendulum assembly (5).

15. A pendulum damping device (2), comprising:
a support (4) according to claim 4, and
at least one pendulum assembly (5) movable with respect to the support (4), the displacement of that pendulum assembly (5) with respect to the support (4) being guided by at least one bearing member (21) interacting on the one hand with the first raceway and on the other hand with at least one second raceway integral with the pendulum assembly (5).

16. A pendulum damping device (2) comprising:
a support (4) according to claim 5, and
at least one pendulum assembly (5) movable with respect to the support (4), the displacement of that pendulum assembly (5) with respect to the support (4) being guided by at least one bearing member (21) interacting on the one hand with the first raceway and on the other hand with at least one second raceway integral with the pendulum assembly (5).

17. The device according to claim 7, comprising a system (30) for attenuating the noise produced upon an impact of the pendulum assembly (5) against the support (4), said system (30) being arranged axially on each side of the second portion (8) of the support (4) and axially clamping the latter.

18. The device according to claim 9, the noise attenuation system (30) being different from an abutment damping member simultaneously coming into contact with the pendulum assembly (5) and the support (4) in order to damp the abutment of the pendulum assembly (5) against the support (4).

19. A method for producing a support for a pendulum damping device, the method comprising the steps of:
cutting out a central zone of a metal sheet to form a first support portion (7) connectable to a component of a vehicle transmission system, the remainder of the metal sheet forming a second support portion (8) having at least one first raceway capable of interacting with a bearing member in order to guide the displacement of a pendulum assembly; and
rigidly connecting the first support portion (7) and the second support portion (8) to one another.

20. The method according to claim 19, further comprising the step of subjecting the second support portion (8) to a hardening treatment following the step of cutting out the metal sheet and before the step of rigidly connecting the first and second support portions (7, 8).
